(19) United States
(12) Patent Application Publication
(10) Pub. No.: US 2026/0303565 A1
(43) Pub. Date: Oct. 1, 2026

(54) ENHANCED VISIBILITY OF DEVICES BEHIND CELLULAR ROUTERS

(71) Applicant: Palo Alto Networks, Inc., Santa Clara, CA (US)

(72) Inventor: Mitchell Rappard, Lee’s Summit, MO (US)

(21) Appl. No.: 19/094,611

(22) Filed: Mar. 28, 2025

(51) Int. Cl. H04L 9/40; H04L 61/256

(52) U.S. Cl. CPC H04L 63/0236; H04L 61/256

(57) ABSTRACT

Techniques for enhanced visibility of devices behind cellular routers using intelligent network address translation (NAT) are disclosed. A cellular router allocates a unique block of ports to each device connecting to the router, performs intelligent NAT using the allocated unique block of ports for each device, and aggregates default device information (e.g., inner IP, outer IP, port block, MAC address, etc.) and optional device related metadata (e.g., device type including manufacturer/make and model, risk assessment, etc.). Router-specific data (e.g., router identifier (ID), location, etc.) can also be included in this aggregated information. The aggregated information is sent to a Device Intelligence Collection Engine (DICE), which distributes the aggregated information to observers (e.g., to security platforms/NGFWs, SIEMs, analytics platforms, etc.) via a publish/subscribe (pub/sub) messaging model, enabling device-specific policy enforcement and analytics in a scalable, hierarchical structure.

### BACKGROUND OF THE INVENTION

As organizations undergo digital transformation, legacy devices traditionally connected via wired networks are increasingly being integrated into wireless networks, such as those utilizing 4G or 5G cellular technology. These devices are often connected through cellular routers or customer premises equipment devices (CPEs) (e.g., Ericsson Enterprise Wireless Solutions' Cradlepoint routers, Palo Alto Networks' PA-4xx-5G, or other commercially available cellular routers/CPEs), which provide cellular wireless connectivity to a mobile packet core. A common practice in such setups is the use of network address translation (NAT) by the CPE to manage traffic egressing towards the mobile core network.

### BRIEF DESCRIPTION OF THE DRAWINGS

Various embodiments of the invention are disclosed in the following detailed description and the accompanying drawings.

FIG. 1 is a prior art diagram of existing approaches to performing network address translation (NAT) for devices behind cellular routers.

FIG. 2 illustrates an example architecture for providing enhanced visibility of devices behind cellular routers using intelligent network address translation (NAT) in accordance with some embodiments.

FIGS. 3A-3C illustrate example data structures for providing enhanced visibility of devices behind cellular routers using intelligent NAT in accordance with some embodiments.

FIG. 4 illustrates a generic call flow for device discovery, showing a device attaching to a CPE, authentication to DICE, and data distribution to observers in accordance with some embodiments.

FIG. 5 illustrates a generic call flow for device discovery, showing a device attaching to a CPE and granular security policy enforcement using a Network Gateway Firewall (NGFW) in accordance with some embodiments.

FIG. 6 illustrates an example architecture for providing enhanced visibility of devices behind cellular routers using intelligent NAT using hierarchical Device Information Collection Engine (DICE) architecture in accordance with some embodiments.

FIG. 7 is a flow diagram of a process for providing enhanced visibility of devices behind cellular routers using intelligent NAT in accordance with some embodiments.

FIG. 8 is another flow diagram of a process for providing enhanced visibility of devices behind cellular routers using intelligent NAT in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall/security rules or firewall/security policies, which can be triggered based on various criteria, such as described herein). A firewall may also apply anti-virus protection, malware detection/prevention, or intrusion protection by applying a set of rules or policies.

Security devices (e.g., security appliances, security gateways, security services, and/or other security devices) can include various security functions (e.g., firewall, anti-malware, intrusion prevention/detection, proxy, and/or other security functions), networking functions (e.g., routing, Quality of Service (QoS), workload balancing of network related resources, and/or other networking functions), and/or other functions. For example, routing functions can be based on source information (e.g., source IP address and port), destination information (e.g., destination IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks'PA Series next generation firewalls, Palo Alto Networks' VM Series virtualized next generation firewalls, and CN Series container next generation firewalls).

For example, Palo Alto Networks' next generation firewalls enable enterprises and service providers to identify and control applications, users, and content—not just ports, IP addresses, and packets—using various identification technologies, such as the following: App-ID™ (e.g., App ID) for accurate application identification, User-ID™ (e.g., User ID) for user identification (e.g., by user or user group), and Content-ID™ (e.g., Content ID) for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency for Palo Alto Networks' PA Series next generation firewalls).

As organizations undergo digital transformation, legacy devices traditionally connected via wired networks are increasingly being integrated into wireless networks, such as those utilizing 4G or 5G cellular technology. These devices are often connected through cellular routers or customer premises equipment devices (CPEs) (e.g., Ericsson Enterprise Wireless Solutions' Cradlepoint routers, Palo Alto Networks' PA-450R-5G, or other commercially available cellular routers/CPEs), which provide cellular wireless connectivity to a mobile packet core. A common practice in such setups is the use of network address translation (NAT) by the CPE to manage traffic egressing towards the mobile core network.

While NAT conserves IP addresses and simplifies network configuration, it obscures the identity of individual devices behind the CPE, as all traffic appears to originate from the CPE's single IP address. As such, the legacy NAT approach generally makes it difficult to determine which traffic belongs to which device, and as a result, this approach generally complicates security rules and enforcement in such network environments. Specifically, this lack of visibility complicates the application of device-specific security policies, analytics, and remediation efforts, particularly in certain network environments, such as large enterprise environments, manufacturing plants, utility providers deploying thousands of such devices, and various other network environments (e.g., particularly large-scale environments).

Existing solutions, such as disabling NAT or relying on IP address differentiation, are generally not efficient or practical for large-scale deployments. Also, these existing solutions generally fail to provide granular device-level visibility for enhanced security rules/policy enforcement. While technologies such as port block allocation (PBA) exist in NAT implementations, such existing technologies do not inherently share device metadata or enable downstream policy enforcement based on, for example, device identity.

Consequently, there exists a need for solutions that preserve the benefits of NAT while providing enhanced visibility of (e.g., and more granular control of) devices behind cellular routers/CPEs.

### Overview of Techniques for Enhanced Visibility of Devices Behind Cellular Routers

As such, various techniques are disclosed that relate generally to network security and device management. Specifically, new and improved techniques for enhancing visibility of (e.g., and enabling policy enforcement for and improved control over) devices behind cellular routers (e.g., and/or customer premises equipment (CPE)) that utilize network address translation (NAT) are disclosed.

For example, various techniques for enhancing visibility of devices behind cellular routers by implementing intelligent NAT functionality are disclosed. In an example implementation, a cellular router (e.g., and/or CPE) assigns unique port blocks to connected devices, performs NAT, and compiles (e.g., collects or aggregates) device information (e.g., inner/inside Internet Protocol (IP) address (IP), outer/outside IP, port range, MAC address, etc.) and optional metadata (e.g., device make/manufacturer, model, risk profile, etc.).

This device information an optional metadata, along with router-specific data (e.g., router ID, location, etc.), is transmitted to a Device Intelligence Collection Engine (DICE). The DICE entity/function can be centralized (e.g., referred to herein as C-DICE) or distributed (e.g., referred to herein as D-DICE) in a hierarchical structure. The DICE distributes this device information and optional metadata to subscribed observers (e.g., next-generation firewalls (NGFWs)/security platforms, Security Information and Event Management (SIEM) tools/platforms, network/security analytics platforms, etc.) using, for example, a publish/subscribe (Pub/Sub) model, enabling device-specific policy enforcement, analytics, and remediation, such as will be further described below with respect to various embodiments.

Multiple data formats (e.g., JSON, XML, TLV, binary) can be supported as will be further described below. Also, various use cases such as device discovery, IP changes, malicious traffic detection, rogue device management, and hierarchical DICE deployments will also be further described below. In an example implementation, existing, commercially available hardware solutions, such as the Palo Alto Networks PA-400 series with IoT or User-ID subscriptions to enrich metadata, can be used to implement the disclosed techniques for enhancing visibility of devices behind cellular routers by implementing intelligent NAT functionality, making it adaptable to various network environments.

In an example implementation, techniques for enhancing visibility of devices behind cellular routers or CPEs by implementing intelligent NAT functionality include allocating blocks of ports to individual devices during NAT, associating these port blocks with device metadata (e.g., device make/manufacturer, device model, device name, operating system (OS) name and version, risk profile, etc.), and securely sharing this information (e.g., using C-DICE or D-DICE for storing this information, such as further described below) with centralized or distributed observers, such as NGFWs/security platforms, tools/platforms, network/security analytics platforms, etc. This facilitates device-specific policy enforcement, visibility, and analytics without requiring Layer 3 (IP address) differentiation (e.g., security policy enforcement can be performed based on this device information and/or metadata information, even though the device traffic can share the same (outer) IP), such as will be further described below.

For example, a cellular router or CPE can assign a unique port block to each device it connects with, perform NAT using these ports, and transmit device associated data (e.g., inner/inside IP, outer/outside IP, port block, MAC address, etc.) along with optional enriched metadata (e.g., device make/manufacturer, device model, device name, operating system (OS) name and version, risk profile, etc.) to a DICE. The DICE, which may be centralized (C-DICE) or distributed (D-DICE), distributes this information to subscribed observers using a publish/subscribe (Pub/Sub) model. Observers can then map traffic to specific devices based on the port block and outside IP and can then apply tailored policies or generate reports.

As such, the disclosed techniques for enhancing visibility of devices behind cellular routers or CPEs by implementing intelligent NAT functionality are advantageous in, for example, private wireless networks, such as those in manufacturing or utility sectors, where legacy devices are integrated into 4G/5G/6G networks (e.g., private 4G/5G/6G enterprise networks, etc.). These and various other example use cases will be further described below.

In some embodiments, a system, a process, and/or a computer program product for enhanced visibility of devices behind cellular routers using intelligent network address translation (NAT) includes allocating a block of ports to a device for network address translation (NAT) operation performed on the device using a cellular router, wherein the device connects to a core cellular network via the cellular router; sharing the block of ports, device information associated with the device, and metadata associated with the device with a device intelligence collection engine (DICE) to facilitate device level visibility of network address translated (NAT'd) network traffic; and performing an action (e.g., enforcing a security policy, generating analytics, and/or performing orchestration) on the NAT'd network traffic, wherein the NAT'd network traffic associated with the device shares a common internal IP address with other devices connected to the core cellular network via the cellular router, and wherein the security policy enforcement on the NAT'd network traffic is performed using one or more of the following: the block of ports, an external IP address associated with the device, the device information associated with the device, and/or the metadata associated with the device.

For example, a plurality of distinct blocks of ports can be allocated to each of a predetermined set of devices using port block allocation (PBA), and wherein each of the plurality of the distinct blocks of ports is associated with a port range.

In an example implementation, the device information associated with the predetermined set of devices includes an inner Internet Protocol (IP) address that corresponds to the internal IP address, an outer IP address that corresponds to the external IP address, a port range, and/or a MAC address. Also, the metadata associated with the device can include, for example, a device manufacturer, a device model, device name, operating system (OS) name and version, and/or a risk profile.

In some embodiments, a hierarchical DICE architecture is deployed in which, for example, the DICE includes a plurality of decentralized DICEs (D-DICEs) that are distributed in a hierarchy that includes at least one centralized DICE (C-DICE).

In some embodiments, the sharing the block of ports, the device information associated with the device, and the metadata associated with the device with the DICE to facilitate device level visibility of NAT'd network traffic is performed using a publish/subscribe (Pub/Sub) communication mechanism.

In some embodiments, the sharing the block of ports, the device information associated with the device, and the metadata associated with the device with the DICE to facilitate device level visibility of NAT'd network traffic are communicated over an encrypted network protocol.

In some embodiments, the DICE distributes the device information associated with the device and the metadata associated with the device to a subscribed observer, wherein the subscribed observer includes a security platform, a Security Information and Event Management (SIEM) platform, and/or a network/security analytics platform.

In some embodiments, a system, a process, and/or a computer program product for enhanced visibility of devices behind cellular routers using intelligent NAT includes allocating, by the cellular router, a unique port block to each of a plurality of devices connected to the cellular router using port block allocation technology; performing intelligent network address translation (NAT) on traffic from each device using the assigned port block; compiling (e.g., collecting or aggregating), for each device, default device information including an inner IP address, an outer IP address, the port block, and a MAC address; compiling (e.g., collecting or aggregating) router information including a unique router identifier and a router location; transmitting the default device information and the router information to a Device Intelligence Collection Engine (DICE); and distributing, by the DICE, the mandatory device information and the router information to one or more subscribed observers using a publish/subscribe (Pub/Sub) model for mapping traffic to each device and performing an action (e.g., security policy enforcement, device and/or network management, logging, and/or another action, such as will be further described below).

In some embodiments, the cellular router authenticates to the DICE using a certificate or credentials prior to transmitting the mandatory device information.

In some embodiments, the observers include at least one of a next-generation firewall (NGFW), an analytics engine, a security information and event management (SIEM) system, or a security orchestration, automation, and response (SOAR) platform.

In some embodiments, a system, a process, and/or a computer program product for enhanced visibility of devices behind cellular routers using intelligent NAT further includes detecting, by an observer, malicious traffic from a device based on the mandatory device information; and signaling the cellular router to disable access or redirect traffic for the device.

In some embodiments, a system for enhanced visibility of devices behind cellular routers using intelligent NAT includes a cellular router configured to: (i) allocate a unique port block to each of a plurality of devices connected thereto; (ii) perform NAT (e.g., intelligent NAT) on traffic from each device using the assigned port block; (iii) compile (e.g., collect or aggregate) mandatory device information including an inner IP address, an outer IP address, the port block, and a MAC address for each device; and (iv) compile (e.g., collect or aggregate) router information including a unique router identifier and a router location; a Device Intelligence Collection Engine (DICE) configured to receive the mandatory device information and the router information from the cellular router; and one or more observers configured to receive the mandatory device information and the router information from the DICE via a publish-subscribe model and map traffic to specific devices based on the port block.

In some embodiments, the cellular router is further configured to compile (e.g., collect or aggregate) optional device information including at least one of a device type, device make, device model, or device risk, and transmit the optional device information to the DICE.

In some embodiments, the DICE is implemented as a distributed DICE (D-DICE) at an edge location and a centralized DICE (C-DICE) in a hierarchical configuration, the C-DICE subscribing to updates from the D-DICE.

In some embodiments, the cellular router includes a device subscription (e.g., an IoT subscription module) configured to provide enriched metadata including at least one of a device make, model, or risk level.

In some embodiments, an observer is configured to request a list of all routers from the DICE, the list including router identifiers and characteristics.

In some embodiments, a system, a process, and/or a computer program product for enhanced visibility of devices behind cellular routers using intelligent NAT includes allocating a unique port block to each of a device connected to a cellular router; performing NAT (e.g., intelligent NAT) on traffic from the device using the assigned port block; compiling (e.g., collect or aggregate) default device information including an inner IP address, an outer IP address, the port block, and a MAC address for the device; compiling (e.g., collect or aggregate) router information including a unique router identifier and a router location; authenticating to a Device Intelligence Collection Engine (DICE) using a certificate or credentials; and transmitting the default device information and the router information to the DICE for distribution to one or more observers.

In some embodiments, a system, a process, and/or a computer program product for enhanced visibility of devices behind cellular routers using intelligent NAT further includes compiling (e.g., collecting or aggregating) optional device information including at least one of a device type, device make, device model, or user identifier, and transmitting the optional device information to the DICE.

In some embodiments, a system, a process, and/or a computer program product for enhanced visibility of devices behind cellular routers using intelligent NAT includes configuring the cellular router to automatically update the DICE with a new inner IP address and device IP time-to-live (TTL) upon detecting an IP change for a device.

These and other embodiments and aspects of the disclosed techniques for enhanced visibility of devices behind cellular routers will now be further described below.

### Example System Embodiments for Enhanced Visibility of Devices Behind Cellular Routers

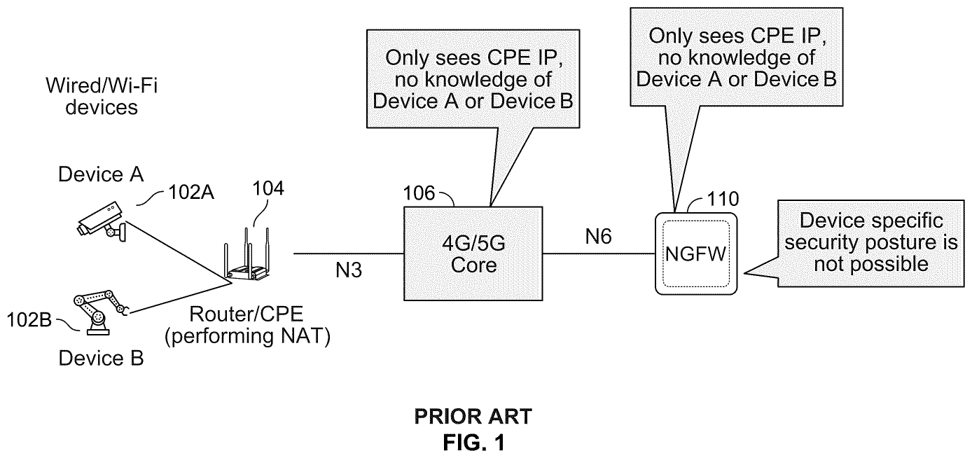

FIG. 1 is a prior art diagram of existing approaches to performing network address translation (NAT) for devices behind cellular routers. Generally, FIG. 1 illustrates the technical challenges associated with the limited visibility behind a cellular router due to traditional NAT approaches in which these devices connected to a CPE with traffic appear as a single IP to an external entity/observer.

Referring to FIG. 1, a Device A 102A and Device B 102B are cellular communications with a Router/CPE 104. The Router/CPE performs traditional NAT on the network traffic prior to sending the network traffic over a user plane interface to a 4G/5G core mobile network 106 (e.g., over an S1 interface in a 4G core mobile network, over an N3 interface for a 5G core mobile network, and/or over a related interface over a 6G core mobile network). As such, there is a lack of visibility of devices behind the CPE/Router in such private or macro wireless network environments performing traditional NAT at the Router/CPE devices as only the Router/CPE IP address is visible at the 4G/5G mobile core network.

Specifically, in this example, Device A 102A and Device B 102B are not visible as a result of the traditional NAT operation performed at Router/CPE 104. As will now be apparent to one of ordinary skill in the art, this technical challenge similarly arises for wired, Wi-Fi, and cellular devices that communicate to the mobile core network via the Router/CPE performing traditional NAT operations on their network traffic.

As a result, external entities/observers can only identify the network traffic as being associated with the IP address of the Router/CPE, and do not have visibility into/knowledge of the devices in communication with the Router/CPE, such as Device A 102A and Device B 102B as shown in this example. As such, a next generation firewall (NGFW) 110 can only identify the network traffic/flows as being associated with Router/CPE 104. Thus, NGFW 110 cannot perform device specific security enforcement as the network traffic/flows cannot be differentiated based on Device A 102A and Device B 102B.

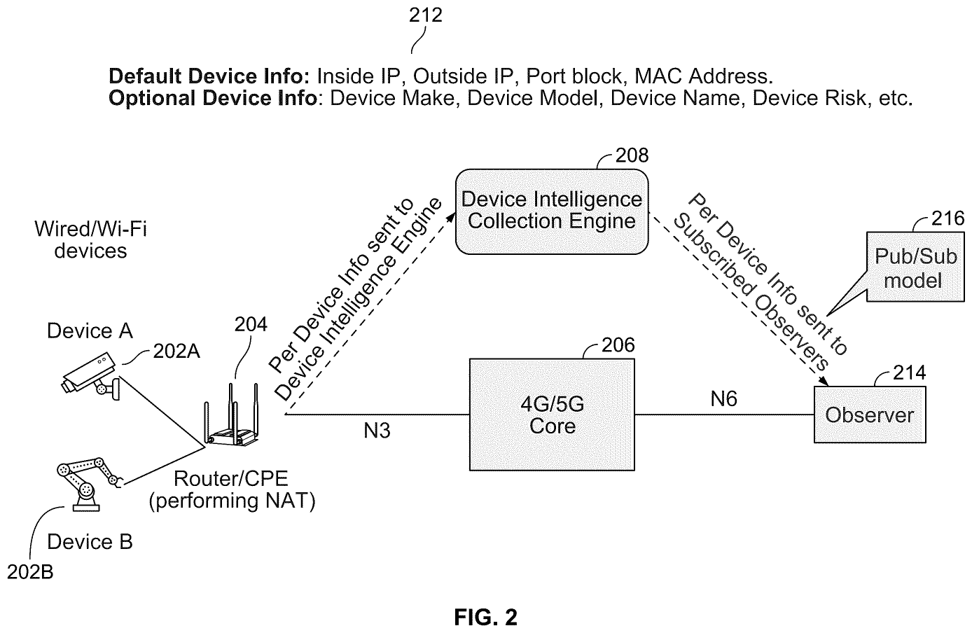

FIG. 2 illustrates an example architecture for providing enhanced visibility of devices behind cellular routers using intelligent network address translation (NAT) in accordance with some embodiments.

Referring to FIG. 2, a Device A 202A and Device B 202B are cellular communications with a Router/CPE 204. The Router/CPE performs NAT on the network traffic, as will be further described below, prior to sending the network traffic over a user plane interface to a 4G/5G core mobile network 206 (e.g., over an S 1 interface in a 4G core mobile network, over an N3 interface for a 5G core mobile network, and/or over a related interface over a 6G core mobile network).

FIG. 2 illustrates a typical setup where devices, such as Device A 202A with, for example, inner IP 10.10.10.5 (e.g., the IP address associated with Device A 202A), and Device B 202B with, for example, inner IP 10.10.10.6 (e.g., the IP address associated with Device B 202B), connect to Router/CPE 204 that performs NAT, translating their respective network traffic to a single outer IP, for example, 203.0.113.1 (e.g., the IP address associated with Router/CPE 204). As a result, external observers 214 (e.g., firewalls/NGFWs and/or other external observers) cannot distinguish between these two distinct devices 202A and 202B, limiting policy granularity.

In this example implementation, CPE/cellular router 204 (e.g., PA-450R-5G or another commercially available CPE/cellular router) is configured to automatically assign unique port blocks to each device (e.g., 1000-1050 for Device A 202A, 1051-1100 for Device B 202B, etc.) during the NAT operation. Further, CPE/cellular router 204 is also configured to automatically collect/aggregate two categories of device data: (1) default device related metadata (e.g., inner IP, outer IP, port range, and MAC address) and optional (e.g., device type, make, model, risk) and router-specific data (e.g., router ID, location, IMSI). This data is sent to a DICE in formats like JSON, XML, TLV, or binary. The DICE, operating in a Pub/Sub model, distributes it to observers, such as NGFWs, SIEMs, or analytics platforms. Observers map traffic to devices using the port range and apply policies or generate reports.

Specifically, CPE/Router 204 (e.g., a Palo Alto Networks PA-450R-5G) connects multiple devices and includes enhanced NAT functionality. This functionality allocates a unique block of ports (e.g., 1700-1750 for Device A, 1751-1800 for Device B) to each device during NAT, which can be implemented using port block allocation (PBA) techniques as further described below. The CPE then compiles (e.g., collects or aggregates) device information, including mandatory fields (inside IP, outside IP, port block, MAC address); and (2) optional device related metadata (e.g., device make/manufacturer, device model, device name, risk assessment/level, etc.). As will be further described below, the CPE/Router transmits the aggregated device related metadata to a Device Intelligence Collection Engine (DICE). The DICE, which may be centralized (C-DICE) or distributed (D-DICE), acts as an intermediary, distributing the aggregated device related data to subscribed observers, such as an NGFW/security platform, analytics/reporting engine/platform, and/or other function/entity.

Generally, port block allocation (PBA) is a translation mode that allocates blocks of ports to device IP instead of individual ports. PBA is commonly used to reduce logging overhead in carrier-grade Network Address Translation (CGN) mode. For example, when a device establishes a network connection, a block of ports is reserved for that device's IP address. When the system releases the block, no more connections are using it. PBA logs only the allocation and release of each block of ports.

In this example implementation, port blocks/range, inside and outside IP, and MAC address are device related metadata that is aggregated at the DICE and (periodically) sent to subscribing observers. For example, each new connection of a device at the Router/CPE for access to the 4G/5G core network 206 can be a trigger for the aggregation of the device related metadata for that device and sharing that aggregated device related metadata for that device to the subscribing observers.

The DICE can store the port blocks/ranges mapped to a plurality of MAC addresses and IP addresses as well as other device related metadata for each new flow/connection, including, for example, Device ID, User ID, Application (App) ID, Equipment ID, Subscriber ID, device type/category, and/or other optional/enhanced meta information.

Specifically, in this example implementation, to provide visibility of devices behind the CPE/Router in such private or macro wireless network environments performing NAT at the Router/CPE devices, a disclosed solution for providing enhanced visibility of devices behind cellular routers using intelligent NAT includes communicating metadata (e.g., device related information) from Router/CPE 204, including for, in this example implementation, device A 202A and Device B 202B, to a Device Intelligence Collection Engine (DICE) 208.

For example, as shown at 212, DICE 208 can be configured to collect/aggregate the following example device information/metadata: inside IP address (e.g., also referred to herein as inner IP), outside IP address (e.g., also referred to herein as outer IP), port block, and MAC address.

As another example, as also shown at 212, DICE 208 can also be configured to collect/aggregate the following example device information/metadata: device make/manufacturer, device model, device name, device risk, and/or other device related information/metadata. As yet another example, various other additional device related metadata can be collected/aggregated by the DICE and shared observers, such as Device-ID and device category/type (e.g., Internet of Things (IoT) device type, Industrial IoT (IIoT) device type, etc.).

In this example implementation, Router/CPE 204 is configured to automatically send the device related information per device to DICE 208. For example, upon a network connection of a device to Router/CPE 204, the above-described device related information can be collected/aggregated and sent to DICE 208 (e.g., using a secure communication protocol).

As also shown in FIG. 2, DICE 208 can distribute the aggregated device related information to an observer 214 using a publish/subscribe (Pub/Sub) model as shown at 216 (e.g., per device information can be sent to subscribed observers, such as further described below). For example, the observers can include different types of entities/functions, such as NGFWs/security platforms, security information and event management (SIEM) platforms, security orchestration, automation, response (SOAR) platforms, analytics/network management/security management platforms, and/or other entities/functions that can utilize this aggregated device information for performing network/security related functions (e.g., policy enforcement using such granular device information), logging (e.g., logging using such granular device information), and/or other functions.

In some implementations, a distributed DICE (D-DICE) and a centralized DICE (C-DICE) are provided, such as will be further described below with respect to various embodiments. In an example implementation, the C-DICE can be configured as another observer of the D-DICE (e.g., a subscriber of the D-DICE), such as will be further described below.

As such, the disclosed solution effectively and efficiently addresses the above-described technical problems associated with the visibility challenge posed by traditional NAT in existing cellular router environments, such as shown in the traditional NAT performed in the cellular router environment shown in and described above with respect to FIG. 1.

Specifically, as similarly described above, DICE 208 collects/aggregates certain device information/metadata: inside IP, outside IP, port block, and MAC address (e.g., and optionally, additional device related information/metadata can include one or more of the following: device make/manufacturer, device model, device name, device risk, and/or other device related information/metadata). As such, inside IP, outside IP, port block, and MAC address are included in the device related metadata that is aggregated at the DICE (e.g., D-DICE), and the aggregated device related metadata is sent to one or more subscribing observers as similarly described above.

The observers can utilize the device related metadata to ascertain device information/granularity. For example, a security platform (e.g., an NGFW or other security platform) can perform granular security policy enforcement using the device related metadata (e.g., distinct security policy enforcement can be performed on Device A 202A and/or on Device B 202B).

In an example implementation, two categories of device related metadata can be sent from the cellular Router/CPE to the DICE and/or directly to the observer: (1) Default device related metadata; and (2) Optional device related metadata. Each set of data contains per device information, such as further described below.

Example Default device related metadata can include the following fields per device:
(1) Inner IP Address (e.g., the IP address of the device, before it is NAT'd);
(2) Outer IP Address (e.g., the IP that the devices have their source IP NAT'd to);
(3) Port Range that will be used for that device (e.g., using PAB techniques as similarly described herein); and/or
(4) MAC Address of the device.

Example Optional device related metadata can include the following fields per device:
(1) A unique ID of the device (e.g., a universally unique ID (UUID) or some other unique string);
(2) Device IP time-to-live (TTL) (e.g., if dynamic);
(3) Device Type;
(4) Device Name;
(5) Device Make;
(6) Device Model;
(7) Device OS;
(8) Device OS Version;
(9) Device Risk;
(10) Device related common vulnerabilities and exposures (CVEs);
(11) Device Interface List;
(12) Device CPU utilization;
(13) Device Memory related statistics;
(14) Device location (e.g., address, latitude/longitude, free form text, etc.);
(15) Device Description;
(16) Device Status; and/or
(17) User of the device (e.g., User ID).

Example Optional device related metadata can include the following router data fields per router:
(1) A unique identifier for the router (e.g., a UUID);
(2) Address of the router (e.g., IP address);
(3) Router location (e.g., address, latitude/longitude, free form text, etc.);
(4) Router device information (e.g., make, model, manufacturer, and other characteristics of the router);
(5) International Mobile Subscriber Identity (IMSI)/Subscription Permanent Identifier (SUPI) of the device (e.g., Subscriber-ID); and/or
(6) International Mobile Equipment Identity (IMEI)/Permanent Equipment Identifier (PEI) of the device (e.g., Equipment-ID).

Thus, unlike prior art approaches using traditional NAT at a Router/CPE in a cellular network environment (e.g., an enterprise/private 4G/5G/6G/etc. cellular network), the disclosed techniques facilitate enhanced visibility into devices behind the Router/CPE (e.g., Router/CPE 204), which can be used by observers (e.g., NGFWs/security functions/platforms, packet cores, SIEM functions/platforms, analytic functions/platforms, logging functions/platforms, management functions/platforms, SOAR functions/platforms, and other functions/entities) to perform actions based on device related metadata collected/aggregated and

### Shared by the Dice (e.g., D-dice And/or C-dice).

As an example, the DICE can send the device related metadata to an NGFW for security policy enforcement of network traffic passing through an enterprise/private cellular network based on enterprise security policy information that includes granular device related security rules.

As another example, the DICE can send the device related metadata to an on-premises (on-prem) and/or cloud-based security management platform for security policy enforcement of network traffic passing through an enterprise/private cellular network based on enterprise security policy information that includes granular device related security rules.

As yet another example, the DICE can send the device related metadata to an on-premises (on-prem) and/or cloud-based analytics/reporting platform or a Security Operations Center (SOC) for analysis of and reporting of network traffic passing through an enterprise/private cellular network based on enterprise security policy information that includes granular device related security rules.

As such, the disclosed techniques for providing enhanced visibility of devices behind cellular routers using intelligent NAT solve the technical challenges associated with private cellular networks in which devices behind the Router/CPE are invisible by aggregating default device related metadata (e.g., Port blocks, inside and outside IP, and MAC address) and sharing this device related metadata with observers. The observers can then utilize the device related metadata to ascertain granular device information, such as for creating and/or enforcing security policies/rules.

As will now be apparent to one of ordinary skill in the art, while FIGS. 2, 4, 5, and 6 are shown with respect to a 4G/5G cellular network environment, the disclosed techniques for providing enhanced visibility of devices behind cellular routers using intelligent NAT can similarly be performed in other/later cellular network environments (e.g., 6G cellular network environments, etc.).

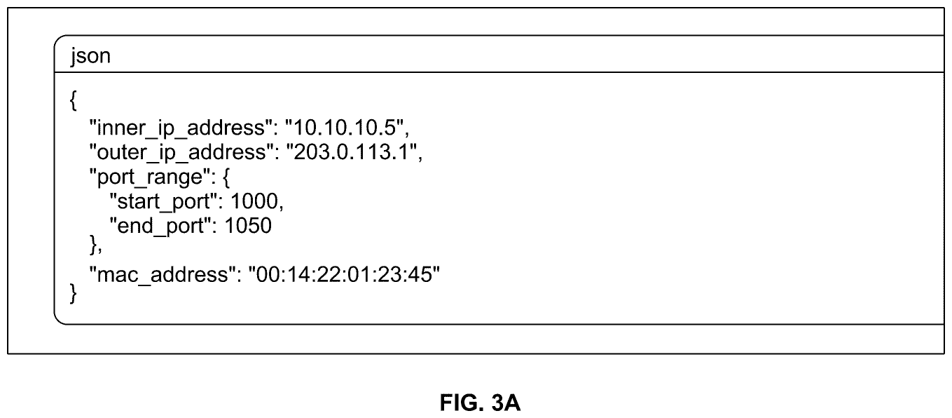

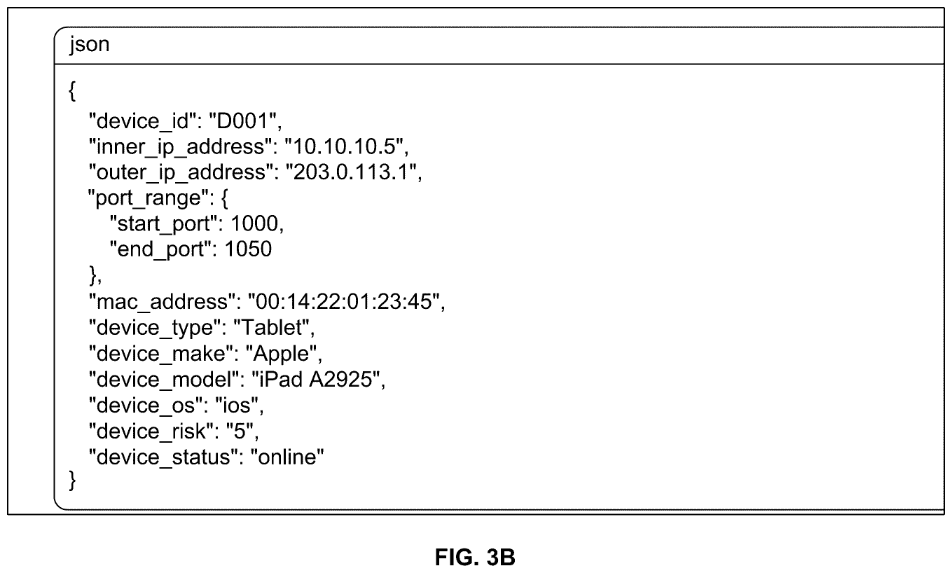

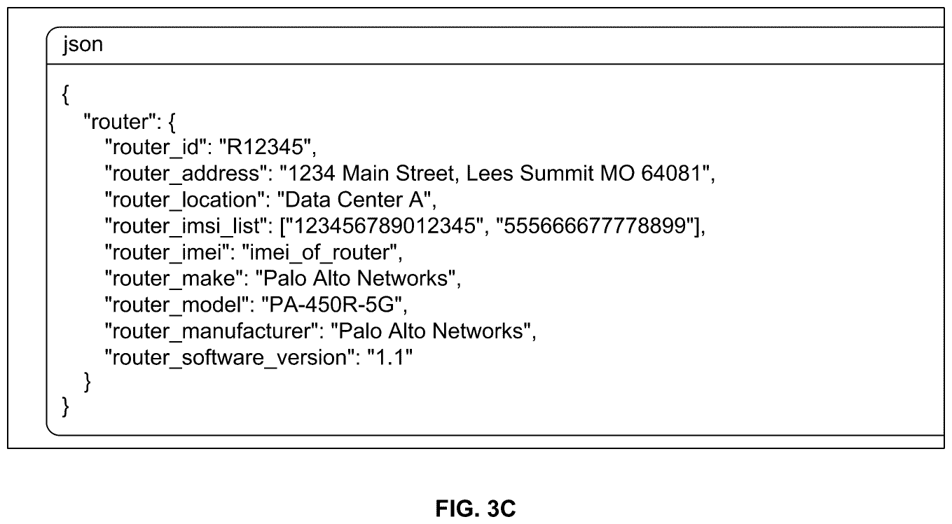

FIGS. 3A-3C illustrate example data structures for providing enhanced visibility of devices behind cellular routers using intelligent NAT in accordance with some embodiments.

In an example implementation, flexible data structures for storing and transmission of device related information/metadata are used, including, for example, JavaScript Object Notation (JSON), eXtensible Markup Language (XML), Tag-Length-Value (TLV), binary, and/or other data structure formats.

As similarly described above with respect to FIG. 2, an example of a default set of device related metadata can include an inner IP address, an outer IP address, a port range, and a MAC address. An example of such a default set of device related metadata in a JSON data structure format is shown in FIG. 3A.

As also similarly described above with respect to FIG. 2, another example of device related metadata includes: (1) a default set of device related metadata, which includes an inner IP address, an outer IP address, a port range, and a MAC address; and (2) an optional set of device related metadata, which includes a device type, device make, device model, device operating system (OS), device risk, and device status. An example of such device related metadata (e.g., including default and optional device related metadata) in a JSON data structure format is shown in FIG. 3B.

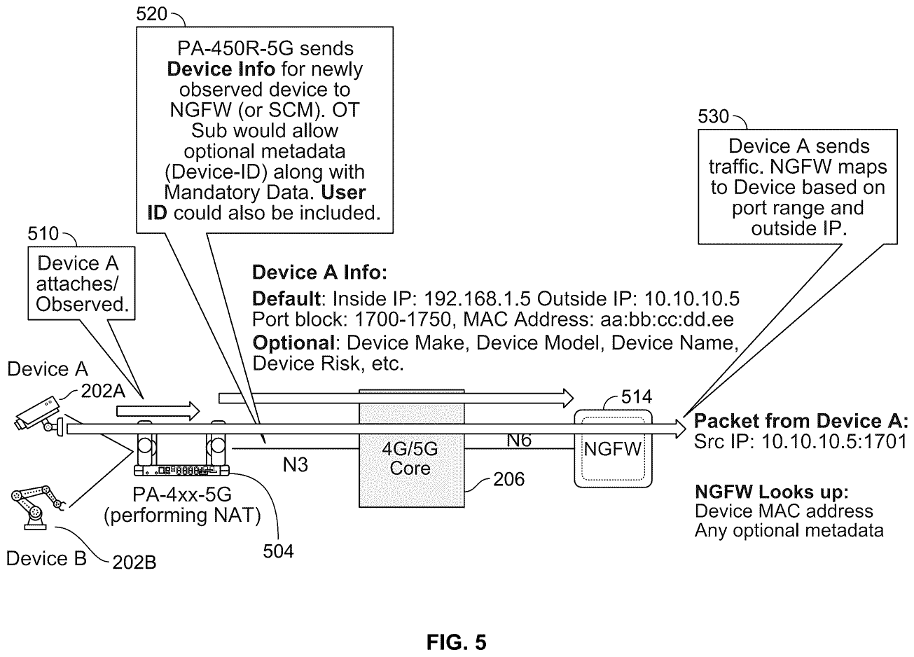

FIG. 3C provides a JSON data structure format for example device related metadata for a CPE/router. In this example implementation, the CPE/router also provides information about itself to the subscribing DICE (e.g., as similarly described above with respect to FIG. 2 and further described below with respect to FIG. 5) and/or directly to the subscribing observer (e.g., as further described below with respect to FIG. 5).

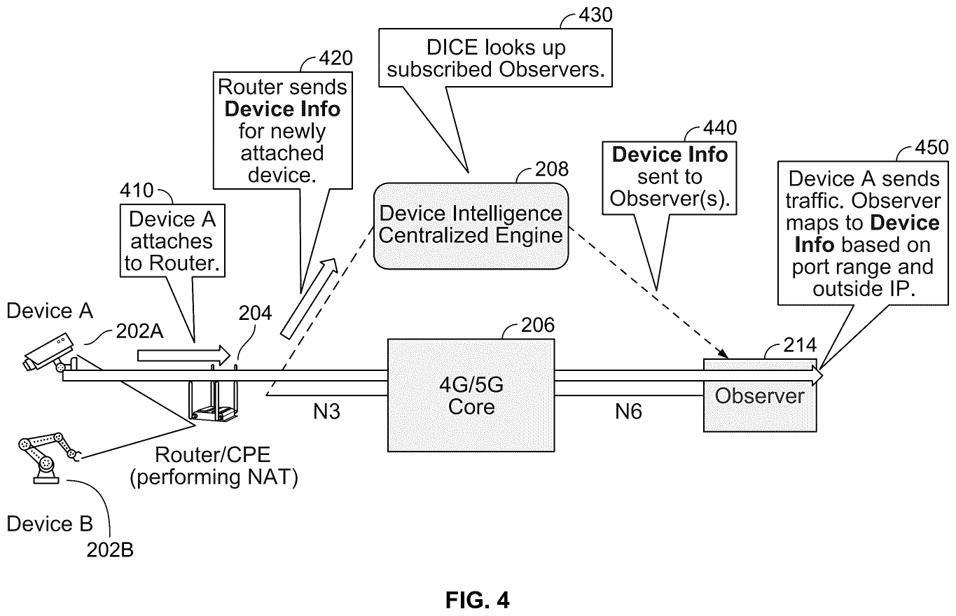

FIG. 4 illustrates a generic call flow for device discovery, showing a device attaching to a CPE, authentication to DICE, and data distribution to observers in accordance with some embodiments.

Referring to FIG. 4, at 410, a device (e.g., Device A 202A as shown) attaches to Router/CPE 204.

At 420, Router/CPE 204 assigns a port range to the newly attached device and collects/aggregates the default device related metadata and, in some cases, the optional device related metadata, such as similarly described above with respect to FIG. 2. In an example implementation, Router/CPE 204 authenticates to DICE 208 (e.g., using a certificate or credentials) and sends the aggregated device related metadata for the newly attached device to the DICE using a secure communication mechanism (e.g., using a secure protocol).

At 430, DICE 208 performs a lookup to identify subscribed observers.

At 440, the aggregated device related metadata is sent to Observer 214 that previously subscribed to receive DICE updates.

At 450, Device A 202A sends network traffic (e.g., user plane (UP) network traffic) via Router/CPE 204 over 4G/5G Core network 206. Observer 214 monitors the network traffic and maps it to the device related metadata based on the port range and outside IP address.

In a first example scenario, only the default device related metadata is sent to the DICE and then to the Observer, in which case the Observer learns the other/optional device related metadata.

In a second example scenario, the default device related metadata and optional device related metadata are both sent to the DICE and then to the Observer, in which case the Observer optionally performs the additional learning operation.

For example, when Device A attaches to the Router/CPE (410), the Router/CPE observes the device, assigns a port block (e.g., 1700-1750), and performs intelligent NAT as similarly described above with respect to FIG. 2 (e.g., that includes assigning a port block to the newly attached device and aggregating device related metadata for sharing with the DICE). The Router/CPE sends the aggregated device related metadata (e.g., Inside IP: 10.10.10.5, Outside IP: 203.0.113.1, Port Block: 1700-1750, MAC: aa:bb:cc:dd:ee:ff) to the DICE (420). The DICE identifies subscribed Observers (430) and sends the aggregated device related metadata to the subscribed Observers (440). Observers can then map incoming network traffic (e.g., using Outside IP: 203.0.113.1:1701) to Device A based on the port block (450). In the case of Observer 214 being, for example, an NGFW, then the NGFW can apply a security policy based on granular device information associated with Device A 202A.

FIG. 5 illustrates a generic call flow for device discovery, showing a device attaching to a CPE and granular security policy enforcement using a Network Gateway Firewall (NGFW) in accordance with some embodiments. In this example implementation, FIG. 5 provides an example call flow using a PA-4xx-5G (e.g., PA-450R-5G, etc.) as shown at 504, illustrating transmission of default and optional data to a subscribing observer, which in this example implementation is shown as an NGFW 514.

Specifically, in this example PA-4xx-5G (504) and NGFW (514) as a subscribed observer scenario, the PA-4xx-5G (504) is configured to aggregate and share the default and optional device related metadata directly with the NGFW (514). As such, a distinct DICE entity/function is not used in this example implementation.

Also, in this example implementation, the optional device related metadata can be provided using an IoT related device security subscription (e.g., device make: Sony, model: Camera Model XYZ), thereby further enhancing NGFW policy enforcement based on granular device related metadata.

Referring to FIG. 5, at 510, a device (e.g., Device A 202A as shown) attaches to PA-4xx-5G 504.

At 520, Router/CPE 204 assigns a port range to the newly attached device and collects/aggregates the default device related metadata and, in this example use case scenario, also aggregates the optional device related metadata, such as similarly described above with respect to FIG. 2. Specifically, in this example implementation, the optional device related metadata can be provided using an IoT related device security subscription (e.g., device make: Sony, model: Camera Model XYZ), thereby further enhancing NGFW policy enforcement based on granular device related metadata that includes both the default and optional device related metadata. In addition, other device related information can similarly be aggregated and shared with NGFW 514, such as User-ID as shown at 520. In this example implementation, PA-4xx-5G 504 authenticates to NGFW 514 (e.g., using a certificate or credentials) and sends the aggregated default and optional device related metadata for the newly attached device to the NGFW (514) using a secure communication mechanism (e.g., using a secure protocol).

At 530, Device A 202A sends network traffic (e.g., user plane (UP) network traffic) via PA-4xx-5G 504 over 4G/5G Core network 206. NGFW 514 monitors the network traffic and maps it to the device related metadata based on the port range (e.g., Port block: 1700-1750 and outside IP address (e.g., Src IP: 10.10.10.5:1701). As such, NGFW 514 can perform enhanced security policy enforcement using the more granular device related information (e.g., NGFW can perform a lookup of the device's MAC address on any other default and optional device related metadata, including for example, User ID, App ID, etc., such as similarly described above) provided as described above at 520.

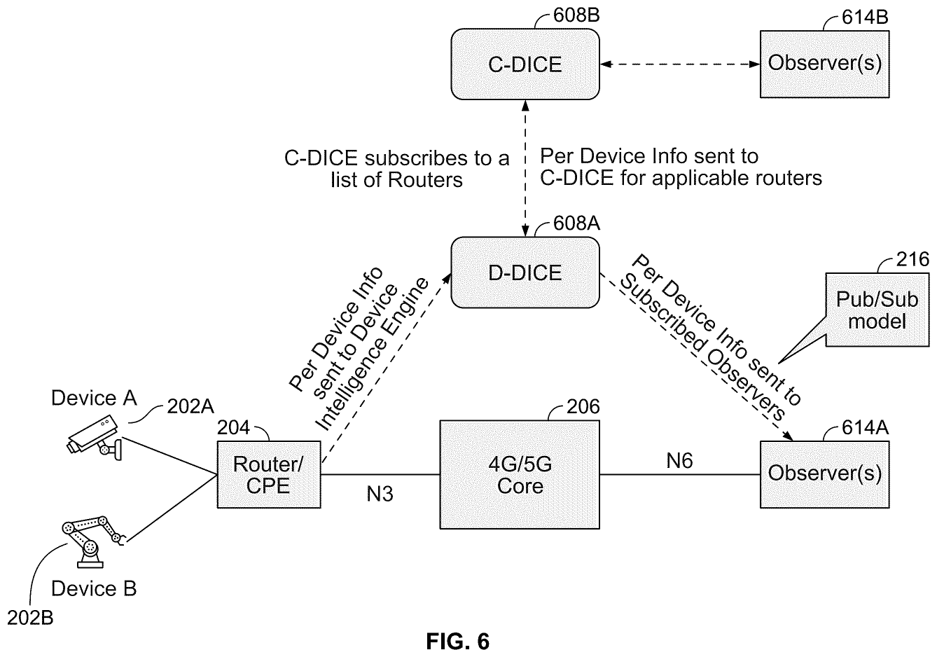

FIG. 6 illustrates an example architecture for providing enhanced visibility of devices behind cellular routers using intelligent NAT using hierarchical Device Information Collection Engine (DICE) architecture in accordance with some embodiments.

Specifically, FIG. 6 illustrates a hierarchical DICE configuration. Distributed DICE (D-DICE) instances at edge locations (e.g., manufacturing plants, branch offices, etc.), such as D-DICE 608A, collect device info from local Routers/CPEs, such as Router/CPE 204, and forward it to a centralized DICE (C-DICE), such as C-DICE 608B, in a data center (e.g., an on-prem data center or cloud-based data center), enabling enterprise-wide visibility and policy enforcement for these enterprise/private cellular network environments, such as similarly described above.

As shown in FIG. 6, observers can subscribe for device related metadata updates from D-DICE 608A, such as Observer(s) 614A. Also, observers can subscribe for device related metadata updates from C-DICE 608B, such as Observer(s) 614B. As also shown in FIG. 6, C-DICE (608B) also subscribes to a list of CPEs/Routers, and the per device information (e.g., device related metadata) is sent to the C-DICE (608B) from the D-DICE (608A) for the applicable routers. In this example implementation, a Pub/Sub communication model as shown at 216 is utilized for observers to receive device related metadata updates from the D-DICE and C-DICE, such as similarly described above with respect to FIG. 2.

As will now be apparent in view of the above-described embodiments, the disclosed techniques support additional features, such as observers requesting a list of Routers/CPEs from a DICE, with authentication ensuring secure communication, such as similarly described above.

As such, the disclosed hierarchical DICE configuration, with D-DICE at the edge and C-DICE aggregating data, facilitates enterprise-wide visibility and policy enforcement for these enterprise/private cellular network environments, such as similarly described above.

### Example Use Cases for Enhanced Visibility of Devices Behind Cellular Routers

Below are various example use cases for enhanced visibility of devices behind cellular routers/CPEs, such as for enterprise/private cellular network environments performing NAT at the cellular router/CPE devices, such as similarly described above with respect to FIGS. 2-6.

Device Discovery (e.g., including at least default device related metadata): A router sends mandatory data to DICE upon device attachment, enabling basic visibility into the device behind the Router/CPE, such as similarly described above.

For example, an interested party (e.g., SIEM, NGFW, SOAR platform, analytics platform, etc.) subscribes to updates to the DICE. The subscription can be based on a list of router (e.g., cellular router) identifiers, device locations/geographies, public IP address ranges, etc.

A router is turned on and configured with the DICE information.

The router authenticates to the DICE using a certificate, username/password, and/or some other form of authentication.

An ethernet device is attached to a wireless router.

The IP address can be allocated in a static or dynamic (DHCP) manner.

The cellular router ascertains the following example information for the devices: (a) IP address of the device; (b) External/NAT'd IP address used for external traffic; (c) Port range for NAT (e.g., 1700-1750); and (d) Device MAC address.

The cellular router sends this information in some format, such as JSON, XML, TLV, Binary, etc., to a centralized DICE (C-DICE).

The C-DICE identifies each of the observers that have subscribed to this cellular router information.

Updates are sent to all subscribers, with the following example information: (a) Cellular router details; (b) IP address of the cellular router device; (c) External/NAT'd IP address used for external traffic; (d) Port range for the NAT (e.g., 1700-1750); and (e) Device MAC address.

Device Discovery (e.g., including default device related metadata and optional device related metadata): Enriched metadata enhances analytics and policy granularity, such as for granular security policy enforcement based on the device related metadata, such as similarly described above.

For example, an interested party (e.g., SIEM, NGFW, SOAR platform, analytics platform, etc.) subscribes to updates to the DICE. The subscription can be based on a list of router (e.g., cellular router) identifiers, device locations/geographies, public IP address ranges, etc.

A router is turned on and configured with the DICE information.

The router authenticates to the DICE using a certificate, username/password, and/or some other form of authentication.

An ethernet device is attached to a wireless router.

The IP address can be allocated in a static or dynamic (DHCP) manner.

The cellular router ascertains the following example fields of information for the devices:
a. The IP address of the device;
b. External/NAT'd IP address used for external traffic;
c. Port range for NAT (e.g., 1700-1750);
d. Device MAC address;
e. Device IP TTL (e.g., if dynamic);
f. Device Type;
g. Device Name;
h. Device Make;
i. Device Model;
j. Device OS;
k. Device OS Version;
l. Device Risk;
m. Device related CVEs;
n. Device Interface List;
o. Device CPU utilization;
p. Device Memory related statistics;
q. Device location (e.g., address, latitude/longitude, free form text, etc.);
r. Device Description;
s. Device Status; and/or
t. Device Confidence.

The cellular router sends this information in some format, such as JSON, XML, TLV, Binary, etc., to a centralized DICE (C-DICE).

The C-DICE identifies each of the observers that have subscribed to this cellular router information.

Updates are sent to all subscribers, with the following example fields of information:
a. The cellular router details;
b. The IP address of the device;
c. External/NAT'd IP address used for external traffic;
d. Port range for NAT (e.g., 1700-1750);
e. Device MAC address;
f. Device IP TTL (e.g., if dynamic);
g. Device Type;
h. Device Name;
i. Device Make;
j. Device Model;
k. Device OS;
l. Device OS Version;
m. Device Risk;
n. Device related CVEs;
o. Device Interface List;
p. Device CPU utilization;
q. Device Memory related statistics;
r. Device location (e.g., address, latitude/longitude, free form text, etc.);
s. Device Description; and/or
t. Device Status.

Device IP Change: The router updates DICE with new IP details, maintaining visibility into the device behind the Router/CPE, such as similarly described above.

For example, an ethernet device is attached to a wireless router.

The IP address of the device changes. This can be performed administratively on the device (e.g., if a static IP) or via a dynamic IP change (e.g., DHCP).

The cellular router sends out an update of all updated fields, along with all default fields, such as similarly described above, including the following example fields:
a. The updated IP address of the device;
b. External/NAT'd IP address used for external traffic;
c. Port range for NAT (e.g., 1700-1750);
d. Device MAC address; and
e. Device IP TTL (e.g., if dynamic).

The cellular router sends this information in some format, such as JSON, XML, TLV, Binary, etc., to a C-DICE.

The C-DICE identifies each of the observers that have subscribed to this cellular router information.

Updates are sent to all subscribers, with the following example fields of information:
a. Cellular router details;
b. IP address of the device;
c. External/NAT'd IP address used for external traffic;
d. Port range for NAT (e.g., 1700-1750);
e. Device MAC address;
f. Device IP TTL (e.g., if dynamic);
g. Device Type;
h. Device Name;
i. Device Make;
j. Device Model;
k. Device OS;
l. Device OS Version;
m. Device Risk;
n. Device related CVEs;
o. Device Interface List;
p. Device CPU utilization;
q. Device Memory related statistics;
r. Device location (e.g., address, latitude/longitude, free form text, etc.);
s. Device Description; and/or
t. Device Status.

Malicious (and/or Unwanted) Traffic Detection: An observer detects unwanted traffic and signals the router to disable or redirect the device based on a security policy, such as similarly described above.

For example, a device sends traffic (e.g., UP traffic) that is deemed unacceptable to the enterprise network (e.g., in violation of one or more rules in an enterprise security policy). As an example, this can be malicious traffic, such as traffic that is associated with malware, an exploit attempt, command and control (C&C traffic activity), a malware URL, or any other form of malicious and/or unwanted traffic.

An observer detects this unwanted traffic, and performs a responsive action, which can include, for example, the following: signal, through an API or some other mechanism, to an orchestration platform used to manage the cellular routers that it should perform an action, such as the following: (i) disable access for the IP/MAC address associated with the infected device; (ii) reduce the throughput and/or modify the quality of service (QoS) for the IP/MAC address associated with the infected device; and/or (iii) redirect the traffic for the affected IP/MAC address (e.g., device).

Device-Specific Policy: An NGFW/security platform uses device related metadata to enforce tailored security policies (e.g., including one or more rules based on device related metadata), such as similarly described above.

For example, a security device/platform, such as an NGFW, acts as an observer, and subscribes to updates for one or more cellular routers.

The routers send the above-described default, and optionally, the optional, device related metadata to the DICE.

The DICE passes this information on to the NGFW that is a subscribed observer.

A security administrator (admin) wants to prohibit, rate limit, redirect, or perform another responsive action for traffic for certain device types, so the security admin configures a security policy with this as a rule that can be implemented using the NGFW.

If the NGFW observer only received the default device related metadata, then using machine learning (ML), heuristic, deep packet inspection (DPI), and/or other techniques, the NGFW observer ascertains additional device information, such as the make, model, type, etc.

If the NGFW observer also received the optional device related metadata about the devices attached to the cellular router, then the NGFW observer can use this information instead of or in addition to the above-described alternative techniques (e.g., ML, heuristic, DPI, etc.) to ascertain the make, model, type, etc. of the devices behind the cellular router(s).

Subsequently, the NGFW observes traffic from the specific device or devices for which a policy has been created.

By observing the source IP address and source port, the NGFW is able to identify the device characteristics of the original device sending the traffic, even though the source IP was NAT'd, and the device MAC is not present in the received traffic monitored at the NGFW.

Policy enforcement can then be effectively and efficiently performed based on the originating device information.

Rogue Device Detection: Observers identify unauthorized devices and trigger responsive actions, such as denial of access, logging, alerting, reporting, and/or other responsive actions that can similarly be performed based on the rogue device detection, such as similarly described above.

For example, an interested party (e.g., SIEM, NGFW, SOAR platform, analytics platform, etc.) subscribes to updates to the DICE. The subscription can be based on a list of router (e.g., cellular router) identifiers, device locations/geographies, public IP address ranges, etc.

A router is turned on and configured with the DICE information.

The router authenticates to the DICE using a certificate, username/password, and/or some other form of authentication.

An ethernet device is attached to a wireless router.

The IP address can be allocated in a static or dynamic (DHCP) manner.

The cellular router ascertains the following example fields of information for the devices:
a. IP address of the device;
b. External/NAT'd IP address used for external traffic;
c. Port range for NAT (e.g., 1700-1750);
d. Device MAC address;
e. Device IP TTL (e.g., if dynamic);
f. Device Type;
g. Device Name;
h. Device Make;
i. Device Model;
j. Device OS;
k. Device OS Version;
l. Device Risk;
m. Device related CVEs;
n. Device Interface List;
o. Device CPU utilization;
p. Device Memory related statistics;
q. Device Location (e.g., address, latitude/longitude, free form text, etc.);
r. Device Description;
s. Device Status; and/or

### T. Device Confidence.

The cellular router sends this information in some format, such as JSON, XML, TLV, Binary, etc., to a C-DICE.

The C-DICE identifies each of the subscribers/observers that have subscribed to this cellular router information.

Updates are sent to all subscribers/observers, with the following example fields of information:
a. Cellular router details;
b. IP address of the device;
c. External/NAT'd IP address used for external traffic;
d. Port range for NAT (e.g., 1700-1750);
e. Device MAC address;
f. Device IP TTL (e.g., if dynamic);
g. Device Type;
h. Device Name;
i. Device Make;
j. Device Model;
k. Device OS;
l. Device OS Version;
m. Device Risk;
n. Device related CVEs;
o. Device Interface List;
p. Device CPU utilization;
q. Device Memory related statistics;
r. Device location (e.g., address, latitude/longitude, free form text, etc.);
s. Device Description; and/or
t. Device Status.

One or more observers notes this device is not allowed on the network (e.g., perhaps it was not authenticated or not included in an allowed list).

This observer can then perform a response action, which can, for example, include a signal, through an API or some other mechanism, to an orchestration platform used to manage the cellular routers that it should perform an action, such as the following: (i) disable access for the IP/MAC of the infected device; and/or (ii) generate an alarm/event/incident via syslog, SNMP, HTTPS, or other communication mechanism to a SOC, network operations center (NOC), and/or other operational entity.

Hierarchical DICE: D-DICE and C-DICE collaborate for scalable enterprise-wide visibility and policy enforcement for these enterprise/private cellular network environments, such

### As Similarly Described Above.

For example, a DICE is deployed locally near the cellular routers that will share information with it. This can be near the wireless packet core, or at the “edge” of the network, or some other location with minimal latency to the cellular router.

Specifically, a C-DICE is configured to subscribe to the D-DICE. To do so the C-DICE sends a subscribe message to the D-DICE. This message can contain information about the cellular routers it is interested in. This message can also optionally indicate that it wants to be notified of any/all cellular routers attached to that D-DICE.

As device information is received by the D-DICE, it sends updates to all observers, including the subscribed C-DICE.

As such, the C-DICE is in this manner another Observer with the exception that it allows other observers to subscribe to it.

Router/CPE Device Discovery: A user can request a list of all Routers/CPEs in their private/enterprise cellular network environment (e.g., a fetch request can be sent to the DICE asking for a Routers/CPEs device list, and the returned list can include all router_id values, and characteristics of that router, such as location, address, etc.), such as similarly described above.

These and various other use cases are facilitated by the disclosed techniques for providing enhanced visibility of devices behind cellular routers using intelligent NAT.

Additional example processes for the disclosed techniques for enhanced visibility of devices behind cellular routers will now be further described below.

### Example Process Embodiments for Enhanced Visibility of Devices Behind Cellular Routers

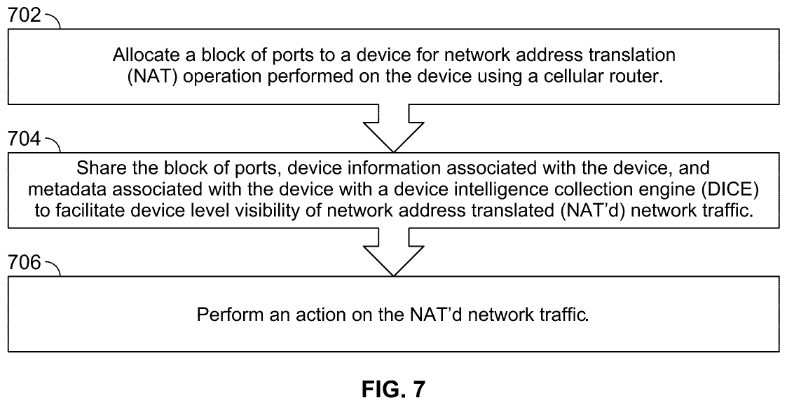

FIG. 7 is a flow diagram of a process for providing enhanced visibility of devices behind cellular routers using intelligent NAT in accordance with some embodiments. In some embodiments, a process as shown in FIG. 7 is performed by the components and techniques as similarly described above including the system embodiments and components described above with respect to FIGS. 2 through 6. In example implementations, the process is performed, at least in part, by the Router/CPE 204 and DICE 208 as described above with respect to FIGS. 2 and 4.

The process begins at 702. At 702, a block of ports is allocated to a device for network address translation (NAT) operation performed on the device using a cellular router. For example, the device is connected to a core cellular network via the cellular router, such as similarly described above with respect to FIG. 2.

At 704, sharing the block of ports, device information associated with the device, and metadata associated with the device with a device intelligence collection engine (DICE) is performed to facilitate device level visibility of network address translated (NAT'd) network traffic. For example, the cellular router can be configured to perform PBA to allocate the block of ports to facilitate intelligent NAT and to share the device information (e.g., default device related metadata) and optional device related metadata, such as similarly described above with respect to FIGS. 2-4.

At 706, an action is performed on the NAT'd network traffic. For example, the NAT'd network traffic associated with the device shares a common internal IP address with other devices connected to the core cellular network via the cellular router. However, an action, such as security policy enforcement on the NAT'd network traffic, can be performed using one or more of the following: the block of ports, an external IP address associated with the device, the device information associated with the device, and/or the metadata associated with the device, such as similarly described above with respect to FIGS. 2-6. Similarly, various other actions can be similarly performed on the NAT'd network traffic, such as analytics, orchestration, and/or other functions, such as similarly described above with respect to FIGS. 2-6 and various use case scenarios/examples described above.

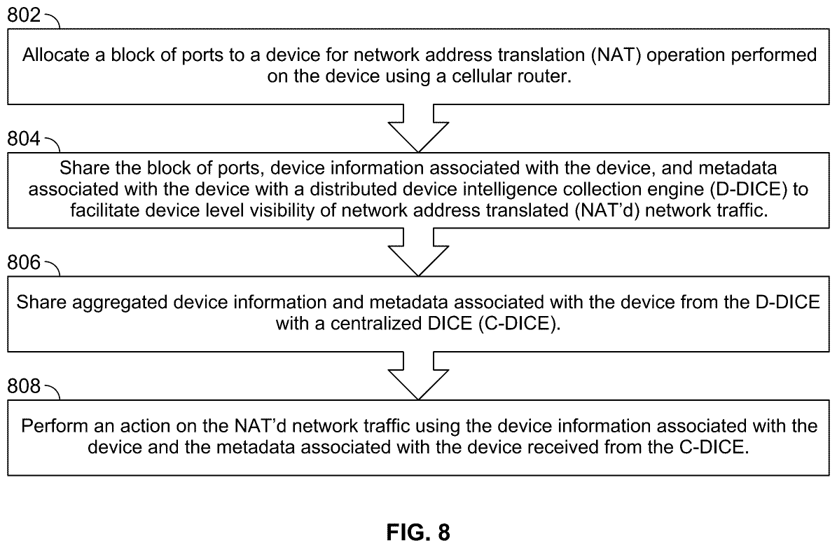

FIG. 8 is another flow diagram of a process for providing enhanced visibility of devices behind cellular routers using intelligent NAT in accordance with some embodiments. In some embodiments, a process as shown in FIG. 8 is performed by the components and techniques as similarly described above including the system embodiments and components described above with respect to FIGS. 2 through 6. In example implementations, the process is performed, at least in part, by the Router/CPE 204 and DICE 208 as described above with respect to FIGS. 2 and 4.

The process begins at 802. At 802, a block of ports is allocated to a device for network address translation (NAT) operation performed on the device using a cellular router. For example, the device is connected to a core cellular network via the cellular router, such as similarly described above with respect to FIG. 2.

At 804, sharing the block of ports, device information associated with the device, and metadata associated with the device with a distributed device intelligence collection engine (D-DICE) is performed to facilitate device level visibility of network address translated (NAT'd) network traffic. For example, the cellular router can be configured to perform PBA to allocate the block of ports to facilitate intelligent NAT and to share the device information (e.g., default device related metadata) and optional device related metadata, such as similarly described above.

At 806, aggregated device information and metadata associated with the device is shared from the D-DICE with a centralized DICE (C-DICE). The C-DICE can be a subscriber of the D-DICE, such as similarly described above with respect to FIG. 6.

At 808, an action is performed on the NAT'd network traffic using the device information associated with the device and the metadata associated with the device received from the C-DICE. For example, the NAT'd network traffic associated with the device shares a common internal IP address with other devices connected to the core cellular network via the cellular router. However, the action (e.g., various types of actions can be performed by different observers, such as similarly described above with respect to various embodiments and use case scenarios) on the NAT'd network traffic can be performed using one or more of the following: the block of ports, an external IP address associated with the device, the device information associated with the device, and/or the metadata associated with the device, which can be received from the C-DICE by subscribing observers of the C-DICE, such as similarly described above with respect to FIG. 6.

For example, an action, such as security policy enforcement on the NAT'd network traffic, can be performed using one or more of the following: the block of ports, an external IP address associated with the device, the device information associated with the device, and/or the metadata associated with the device, such as similarly described above with respect to FIGS. 2-6. Similarly, various other actions can be similarly performed on the NAT'd network traffic, such as analytics, orchestration, and/or other functions, such as similarly described above with respect to FIGS. 2-6 and various use case scenarios/examples described above.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
allocate a block of ports to a device for a network address translation (NAT) operation performed on the device using a cellular router, wherein the device connects to a core cellular network via the cellular router;
share the block of ports, device information associated with the device, and metadata associated with the device with a device intelligence collection engine (DICE) to facilitate device level visibility of network address translated (NAT'd) network traffic; and
perform an action on the NAT'd network traffic, wherein the NAT'd network traffic associated with the device shares a common internal IP address with other devices connected to the core cellular network via the cellular router, and wherein the action performed on the NAT'd network traffic is performed using one or more of the following:
the block of ports, an external IP address associated with the device, the device information associated with the device, and/or the metadata associated with the device; and
a memory coupled to the processor and configured to provide the processor with instructions.

2. The system of claim 1, wherein a plurality of distinct blocks of ports are allocated to each of a predetermined set of devices using port block allocation (PBA), and wherein each of the plurality of the distinct blocks of ports is associated with a port range.

3. The system of claim 1, wherein the device information associated with the device includes an inner Internet Protocol (IP) address that corresponds to the internal IP address, an outer IP address that corresponds to the external IP address, a port range, and/or a MAC address.

4. The system of claim 1, wherein the metadata associated with the device includes a device manufacturer, a device model, a device name, an operating system (OS) name and version, and/or a risk profile.

5. The system of claim 1, wherein the action includes one or more of the following: enforcing a security policy, generating analytics, and/or performing orchestration.

6. The system of claim 1, wherein the DICE includes a decentralized DICE (D-DICE).

7. The system of claim 1, wherein the DICE includes a plurality of decentralized DICEs (D-DICEs) that are distributed in a hierarchy that includes at least one centralized DICE (C-DICE).

8. The system of claim 1, wherein the sharing the block of ports, the device information associated with the device, and the metadata associated with the device with the DICE to facilitate the device level visibility of the NAT'd network traffic is performed using a publish/subscribe (Pub/Sub) communication mechanism.

9. The system of claim 1, wherein the sharing the block of ports, the device information associated with the device, and the metadata associated with the device with the DICE to facilitate device level visibility of NAT'd network traffic is communicated over an encrypted network protocol.

10. The system of claim 1, wherein the DICE distributes the device information associated with the device and the metadata associated with the device to a subscribed observer, wherein the subscribed observer includes a security platform, a Security Information and Event Management (SIEM) platform, and/or a network/security analytics platform.

11. A method, comprising:
allocating a block of ports to a device for a network address translation (NAT) operation performed on the device using a cellular router, wherein the device connects to a core cellular network via the cellular router;
sharing the block of ports, device information associated with the device, and metadata associated with the device with a device intelligence collection engine (DICE) to facilitate device level visibility of network address translated (NAT'd) network traffic; and
performing an action on the NAT'd network traffic, wherein the NAT'd network traffic associated with the device shares a common internal IP address with other devices connected to the core cellular network via the cellular router, and wherein the action performed on the NAT'd network traffic is performed using one or more of the following: the block of ports, an external IP address associated with the device, the device information associated with the device, and/or the metadata associated with the device.

12. The method of claim 11, wherein a plurality of distinct blocks of ports are allocated to each of a predetermined set of devices using port block allocation (PBA), and wherein each of the plurality of the distinct blocks of ports is associated with a port range.

13. The method of claim 11, wherein the device information associated with the device includes an inner Internet Protocol (IP) address that corresponds to the internal IP address, an outer IP address that corresponds to the external IP address, a port range, and/or a MAC address.

14. The method of claim 11, wherein the metadata associated with the device includes a device manufacturer, a device model, a device name, an operating system (OS) name and version, and/or a risk profile.

15. The method of claim 11, wherein the action includes one or more of the following:
enforcing a security policy, generating analytics, and/or performing orchestration.

16. The method of claim 11, wherein sharing the block of ports, the device information associated with the device, and the metadata associated with the device with the DICE to facilitate the device level visibility of the NAT'd network traffic is performed using a publish/subscribe (Pub/Sub) communication mechanism.

17. A computer program product embodied in a non-transitory computer readable medium and comprising computer instructions for:
allocating a block of ports to a device for a network address translation (NAT) operation performed on the device using a cellular router, wherein the device connects to a core cellular network via the cellular router;
sharing the block of ports, device information associated with the device, and metadata associated with the device with a device intelligence collection engine (DICE) to facilitate device level visibility of network address translated (NAT'd) network traffic; and
performing an action on the NAT'd network traffic, wherein the NAT'd network traffic associated with the device shares a common internal IP address with other devices connected to the core cellular network via the cellular router, and wherein the action performed on the NAT'd network traffic is performed using one or more of the following: the block of ports, an external IP address associated with the device, the device information associated with the device, and/or the metadata associated with the device.

18. The computer program product of claim 17, wherein a plurality of distinct blocks of ports are allocated to each of a predetermined set of devices using port block allocation (PBA), and wherein each of the plurality of the distinct blocks of ports is associated with a port range.

19. The computer program product of claim 17, wherein the device information associated with the device includes an inner Internet Protocol (IP) address that corresponds to the internal IP address, an outer IP address that corresponds to the external IP address, a port range, and/or a MAC address.

20. The computer program product of claim 17, wherein the metadata associated with the device includes a device manufacturer, a device model, a device name, an operating system (OS) name and version, and/or a risk profile.
